(19) United States
(12) Patent Application Publication
(10) Pub. No.: US 2019/0326796 A1
(43) Pub. Date: Oct. 24, 2019

(54) ROTARY MACHINE

(71) Applicant: SINFONIA TECHNOLOGY CO., LTD., Tokyo (JP)

(72) Inventors: Hiroki Wakabayashi, Tokyo (JP); Masashi Kutsuna, Tokyo (JP); Yutaka Wakita, Tokyo (JP); Tetsuhiro Tomita, Tokyo (JP)

(73) Assignee: SINFONIA TECHNOLOGY CO., LTD., Tokyo (JP)

(21) Appl. No.: 16/390,286

(22) Filed: Apr. 22, 2019

(30) Foreign Application Priority Data
Apr. 23, 2018 (JP) 2018-082341

(51) Int. Cl. H02K 9/193; H02K 7/00; H02K 7/08

(52) U.S. Cl. CPC H02K 9/193; H02K 7/083; H02K 7/003

(57) ABSTRACT

A shaft includes a main refrigerant passage capable of supplying a refrigerant in one direction on an axial center part and a test piece side sub-refrigerant passage having a starting end communicating with the vicinity of a downstream end in a refrigerant supply direction of the main refrigerant passage. The downstream end in the refrigerant supply direction of the main refrigerant passage is set at the position before an end of the shaft at the side to which a test piece is connected and a predetermined position on the downstream side in the refrigerant supply direction relative to a test piece side bearing. An ending end (discharge port) of the test piece side sub-refrigerant passage is set on the upstream side (counter test piece side) in the refrigerant supply direction relative to the test piece side bearing.

### BACKGROUND OF THE INVENTION

### (1) Field of the Invention

The present invention relates to, for example, a rotary machine of an automobile testing apparatus.

### (2) Description of Related Art

A rotary machine (dynamo device) which is coupled to an output shaft of a test piece and functions as a “dummy load” or a “dummy driving source” is used in an automobile testing apparatus for evaluating the characteristics of a vehicle driving system such as an electric motor, a generator, an engine, or a power train, as the test piece.

The rotary machine is provided with a casing having a cylindrical shape and a stator and a rotor which are disposed inside the casing, and capable of integrally rotating the rotor fixed around a shaft with the shaft. For example, the rotary machine of the automobile testing apparatus requires high-speed rotation and a large capacity, and generates a larger amount of heat than an ordinary motor. Thus, it is necessary to reduce heat generated from the stator or the rotor inside the casing. In particular, an increase in the capacity of the rotary machine results in an increase in the size of a bearing, and the combination of the increase in the capacity of the rotary machine and the high-speed rotation of the shaft increase a frictional loss of the bearing. Thus, it is necessary to increase the cooling capacity with respect to the bearing.

JP 2007-159325 A discloses a cooling mechanism. The cooling mechanism includes an oil supply passage (in-shaft hole) which extends in an axial direction on the axial center of a shaft, a radial hole (injection nozzle) which communicates with the oil supply passage, and a reflection cone including an inclined surface having a predetermined inclination angle for guiding cooling oil injected from the injection nozzle in a splashed or mist form to a coil end of a coil. JP 2007-159325 A also discloses that part of the splashed or mist cooling oil colliding with the inclined surface of the reflection cone is supplied also to the bearing through the reflection cone by the gravity so that the cooling oil can be used also as a lubricating oil of the bearing.

JP 2008-289279 A discloses a configuration in which a thrust oil passage (in-shaft hole) extending in a thrust direction for circulating a lubricating oil and a radial oil passage extending in a radial direction of a shaft part from the thrust oil passage are formed on a shaft, and the position of at least one radial oil passage is set on the downstream side relative to a test piece side bearing in a lubricating oil supply direction in the thrust oil passage. JP 2008-289279 A also discloses a configuration that guides a lubricating oil discharged through an opening of the radial oil passage by a guide member which includes an inclined part inclined toward the bearing.

However, in the configuration described in JP 2007-159325 A, since the downstream end of the oil supply passage (in-shaft hole) formed on the axial center of the shaft is set at the position on the upstream side in the supply direction relative to the test piece side bearing, it is not possible to pass the refrigerant supplied to the oil supply passage up to the vicinity of the test piece side bearing, and the separation distance between the oil supply passage and the test piece side bearing is increased, which increases the thermal resistance. Accordingly, it is not possible to completely take heat generated from the test piece side bearing, and it is difficult to exhibit a sufficient cooling capacity with respect to the test piece side bearing. Thus, it is difficult to maintain the temperature of the bearing within an allowable range. Further, since the radial hole (injection nozzle) described in JP 2007-159325 A linearly extends in the radial direction from the downstream end of the in-shaft hole, the refrigerant oil injected through the radial hole cannot be directly sprayed to the test piece side bearing. Thus, it is considered that it is difficult to exhibit a sufficient cooling capacity with respect to the test piece side bearing.

On the other hand, in the rotary machine described in JP 2008-289279 A, since the thrust oil passage is formed throughout the entire length of the shaft, the separation distance between the test piece side bearing and a cooling surface (thrust oil passage) is shorter than that in the configuration described in JP 2007-159325 A. Accordingly, a high-low difference in heat is small by the reduction in the distance, and the cooling capacity with respect to the test piece side bearing is increased.

However, in the rotary machine described in JP 2008-289279 A, as described above, since the thrust oil passage is formed throughout the entire length of the shaft, a problem may occur that the refrigerant oil discharged becoming splashed or atomized form through the radial hole and leak to the outside of the rotary machine through a gap on a shaft end. Even in a configuration in which a high-performance mechanical seal is disposed at an appropriate position to fill the gap on the shaft end, it is difficult to completely prevent leakage of the refrigerant oil to the outside of the rotary machine through the gap on the shaft end during high-speed rotation.

### SUMMARY OF THE INVENTION

The present invention has been made by focusing on the above problem, and a principal object thereof is to provide a rotary machine capable of preventing leakage of a refrigerant to the outside of a casing and effectively cooling a test piece side bearing.

Specifically, the present invention relates to a rotary machine including: a shaft including a main refrigerant passage capable of supplying a refrigerant in one direction on an axial center part and having one end part to which a test piece can be connected; a rotor disposed around an axis of the shaft, a casing capable of housing at least a part of the rotor and a part of the shaft in an internal space of the casing; a stator fixed inside the casing; a test piece side bearing that is disposed near the one end part of the shaft and rotatably supports the shaft; and a counter test piece side bearing that is disposed near the other end part of the shaft and rotatably supports the shaft.

Further, in the rotary machine according to the present invention, a downstream end in a refrigerant supply direction of the main refrigerant passage is set at a position before an end of the shaft at a side to which the test piece is connected and the same position as the test piece side bearing or a predetermined position on a downstream side relative to the test piece side bearing in the refrigerant supply direction, and the shaft includes a test piece side sub-refrigerant passage having a starting end communicating with the downstream end in the refrigerant supply direction or a vicinity of the downstream end in the refrigerant supply direction of the main refrigerant passage and an ending end communicating with the internal space of the casing, and the ending end of the test piece side sub-refrigerant passage is set on an upstream side (the counter test piece side) in the refrigerant supply direction relative to the test piece side bearing.

The “refrigerant supply direction” in the present invention indicates the supply direction of the refrigerant in the main refrigerant passage capable of supplying the refrigerant in one direction and corresponds to the direction from the other end (the end at the side to which no test piece is connected) toward the one end (the end at the side to which the test piece is connected) in the shaft. Further, “setting the downstream end in the refrigerant supply direction of the main refrigerant passage at the same position as the test piece side bearing in the refrigerant supply direction” has the same meaning as “setting the downstream end in the refrigerant supply direction of the main refrigerant passage at the position overlapping at least a part of the test piece side bearing in the radial direction of the shaft (the direction perpendicular to the axial direction of the shaft).

The rotary machine according to the present invention is capable of taking not only heat generated from the counter test piece side bearing and the rotor, but also heat generated from the test piece side bearing by the refrigerant flowing toward the downstream end (test piece side) in the main refrigerant passage. In particular, in the rotary machine of the present embodiment, the downstream end of the main refrigerant passage is set at the same position as the test piece side bearing or the predetermined position on the downstream side relative to the test piece side bearing in the refrigerant supply direction. Thus, the distance between the test piece side bearing as a heating element and the main refrigerant passage as a cooling surface is shorter than that in the configuration in which the downstream end of the main refrigerant passage is set on the upstream side relative to the test piece side bearing in the refrigerant supply direction, which reduces the thermal resistance and increases the cooling capacity with respect to the test piece side bearing by the refrigerant that has reached the downstream end of the main refrigerant passage.

Further, the rotary machine according to the present invention employs the configuration (a first condition relating to the main refrigerant passage) in which the downstream end in the refrigerant supply direction of the main refrigerant passage is set at the position before the end of the shaft at the side to which the test piece is connected, the configuration (a first condition relating to the test piece side sub-refrigerant passage) in which the starting end of the test piece side sub-refrigerant passage communicates with the downstream end in the refrigerant supply direction of the main refrigerant passage or the vicinity of the downstream end in the supply direction and the ending end of the test piece side sub-refrigerant passage communicates with the internal space of the casing, and the configuration (a second condition relating to the test piece side sub-refrigerant passage) in which the ending end of the test piece side sub-refrigerant passage is set on the upstream side (the counter test piece side) in the refrigerant supply direction relative to the test piece side bearing. Accordingly, it is possible to prevent or reduce contamination of the test piece caused by leakage of the refrigerant that has passed through the main refrigerant passage to the outside of the rotary machine. Further, the distance between the test piece side bearing as the heating element and the cooling surface (the main refrigerant passage) is shorter than that in the configuration in which the downstream end of the main refrigerant passage is set on the upstream side relative to the test piece side bearing in the refrigerant supply direction, which reduces the thermal resistance and increases the capacity of taking heat generated from the test piece side bearing (the cooling capacity) by the refrigerant that has reached the downstream end of the main refrigerant passage.

Further, although the test piece side sub-refrigerant passage in the present invention may have any shape that satisfies the first and second conditions relating to the test piece side sub-refrigerant passage, the test piece side sub-refrigerant passage can be formed on the shaft by relatively simple processing when the test piece side sub-refrigerant passage is configured as a flow passage inclined by a predetermined angle from the starting end toward the ending end.

The present invention also includes a rotary machine including a counter test piece side sub-refrigerant passage which is a flow passage similar to the test piece side sub-refrigerant passage and formed on the shaft. That is, the rotary machine according to the present invention may include the counter test piece side sub-refrigerant passage having a starting end communicating with a predetermined part of the main refrigerant passage on the upstream end side in the refrigerant supply direction relative to the test piece side bearing and an ending end communicating with the internal space of the casing on the downstream side in the refrigerant supply direction relative to the counter test piece side bearing. In such a rotary machine, when the shape, the angle, and the number of the counter test piece side sub-refrigerant passage are the same as those of the test piece side sub-refrigerant passage, it is possible to avoid the generation of a difference in a centrifugal pump action between the test piece side and the counter test piece side, and equally emit the refrigerant into the internal space of the housing from the counter test piece side sub-refrigerant passage and the test piece side sub-refrigerant passage. However, the shape, the angle, and the number of the counter test piece side sub-refrigerant passage may differ from those of the test piece side sub-refrigerant passage. In this case, the shape (including the radius), the angle, and the number of each sub-refrigerant passage may be appropriately set so that there is no difference in the centrifugal pump action.

According to the present invention, the main refrigerant passage (in-shaft hole) having the ending end set at the position near the end of the shaft at the side to which the test piece is connected is formed on the axial center part of the shaft, the test piece side sub-refrigerant passage having the starting end communicating with the vicinity of the downstream end of the main refrigerant passage is formed on the outer peripheral edge part (thick part) of the shaft, the outer peripheral edge part surrounding the axial center part (hollow part) and having an annular sectional shape, and the ending end (discharge port) of the test piece side sub-refrigerant passage is set at the position on the upstream side in the refrigerant supply direction relative to the test piece side bearing. Thus, it is possible to provide the rotary machine capable of preventing insufficient cooling with respect to the test piece side bearing caused by increases in capacity and rotation speed, capable of cooling the heating element such as the rotor using the refrigerant discharged into the internal space of the casing after flowing toward the other end side (the side to which no test piece is connected) of the shaft through the test piece side sub-refrigerant passage, and also capable of preventing leakage of the refrigerant to the outside of the rotary machine.

### BRIEF DESCRIPTION OF THE DRAWINGS

FIG. 1 is a schematic sectional view of a rotary machine according to an embodiment of the present invention;

FIG. 2 is an enlarged schematic sectional view of a principal part of the rotary machine according to the embodiment;

FIG. 3 is a diagram illustrating a comparative example of the rotary machine according to the embodiment correspondingly to FIG. 2;

FIG. 4 is a diagram illustrating a first modification of the rotary machine according to the embodiment;

FIG. 5 is a diagram illustrating a second modification of the rotary machine according to the embodiment;

FIG. 6 is a diagram illustrating a third modification of the rotary machine according to the embodiment; and

FIG. 7 is a diagram illustrating a fourth modification of the rotary machine according to the embodiment.

### DETAILED DESCRIPTION OF PREFERRED EMBODIMENTS

Hereinafter, an embodiment of the present invention will be described with reference to the drawings.

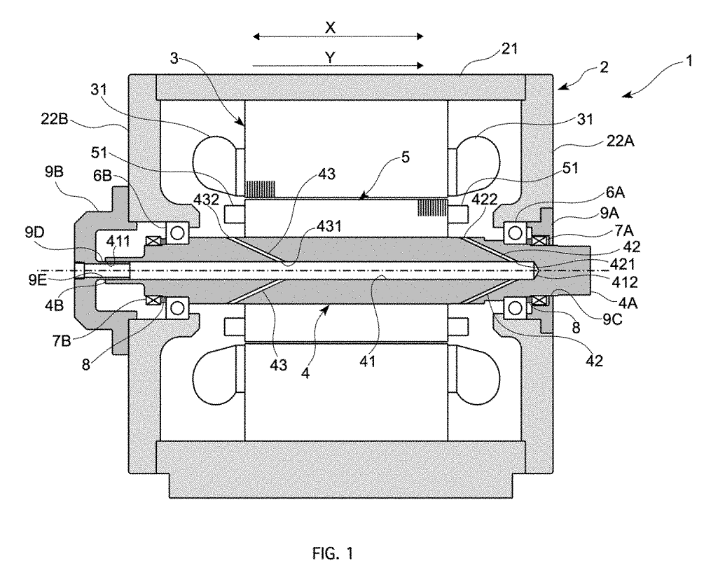

As illustrated in FIG. 1, a rotary machine 1 according to the present embodiment includes a casing 2 having a cylindrical shape, a stator 3 which is fixed inside the casing 2, a shaft 4, a rotor 5 which is disposed around an axis of the shaft 4, and bearings (a test piece side bearing 6A and a counter test piece side bearing 6B) which rotatably support the shaft 4. The rotary machine 1 according to the present embodiment, for example, functions as a dynamo device which is used in an automobile testing apparatus. When the rotary machine 1 is used in the automobile testing apparatus, it is possible to measure the characteristics of a test piece (e.g., a rotary body (power train) used in an automobile, not illustrated) which is coupled to the rotary machine 1. The rotary machine 1 functions as a “dummy load” or a “dummy driving source” according to the type of the test piece.

The casing 2 includes a casing body 21 having a substantially cylindrical shape, the casing body 21 being disposed in a lying attitude along an axial direction X of the shaft 4, a test piece side cover 22A which is attached to one end part of the casing body 21, and a counter test piece side cover 22B which is attached to the other end part of the casing body 21. The “test piece side” and the “counter test piece side” are also referred to as a “load side” and a “counter load side” or a “primary side (P side)” and a “secondary side (S side)”, respectively. The test piece side cover 22A includes a through hole capable of housing the test piece side bearing 6A on the central part thereof. The counter test piece side cover 22B includes a through hole capable of housing the counter test piece side bearing 6B on the central part thereof.

The test piece side bearing 6A housed in the through hole of the test piece side cover 22A and the counter test piece side bearing 6B housed in the through hole of the counter test piece side cover 22B are supported by bearing support members (a test piece side bearing support member 7A and a counter test piece side bearing support member 7B), respectively. In the present embodiment, spacers 8 are interposed between the test piece side bearing 6A and the test piece side bearing support member 7A and between the counter test piece side bearing 6B and the counter test piece side bearing support member 7B.

A test piece side sub-cover 9A is disposed on the central part of the test piece side cover 22A. The test piece side sub-cover 9A fills a gap between the test piece side cover 22A and the shaft 4 near one end 4A in the radial direction of the shaft 4. Further, a through hole 9C is formed on the central part of the test piece side sub-cover 9A so that a part of the shaft 4 near the one end 4A (the test piece side end) is exposed to the outside of the casing 2 through the through hole 9C. On the other hand, the counter test piece side sub-cover 9B is provided with a connecting part 9D on the central part thereof. The connecting part 9D projects toward the test piece side and is connectable to a predetermined part including the other end 4B of the shaft 4.

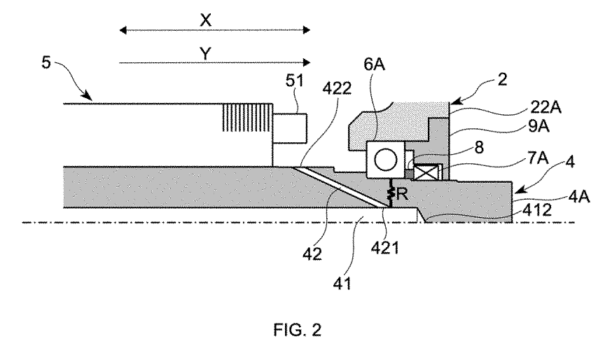

The outer peripheral face of the test piece side bearing 6A is fixed by the test piece side cover 22A, and the inner peripheral face thereof is set as a sliding contact face with respect to the shaft 4. The outer peripheral face of the counter test piece side bearing 6B is fixed by the counter test piece side cover 22B, and the inner peripheral face thereof is set as a sliding contact face with respect to the shaft 4. The outer peripheral face of the shaft 4 includes steps which define attachment positions of the test piece side bearing 6A and the counter test piece side bearing 6B with respect to the shaft 4. In the rotary machine 1 of the present embodiment, the bearings (the test piece side bearing 6A and the counter test piece side bearing 6B) are sandwiched between the steps and the spacers 8 and the bearing support members (the test piece side bearing support member 7A and the counter test piece side bearing support member 7B) to restrict movements of the bearings (the test piece side bearing 6A and the counter test piece side bearing 6B) in the axial direction X. FIGS. 1 and 2 omit members and bolts for attaching the covers (the test piece side cover 22A and the counter test piece side cover 22B) to the casing body 21 and attaching the sub-covers (the test piece side sub-cover 9A and the counter test piece side sub-cover 9B) to the covers (the test piece side cover 22A and the counter test piece side cover 22B). In the rotary machine 1 of the present embodiment, an internal space of the casing 2 defined by the casing body 21, the covers (the test piece side cover 22A and the counter test piece side cover 22B), and the sub-covers (the test piece side sub-cover 9A and the counter test piece side sub-cover 9B) can be maintained as a highly airtight space separated from an external space. The internal space of the casing 2 is a space annularly continuous in the circumferential direction of the shaft 4.

A known stator and a known rotor can be used as the stator 3 and the rotor 5 which are disposed in the internal space of the casing 2. Thus, detail description thereof will be omitted. As illustrated in FIG. 1, coil ends 31 are disposed on both ends in the axial direction X of the stator 3, and end rings 51 are disposed on both ends in the axial direction X of the rotor 5.

The shaft 4 has one end part to which the test piece can be connected and includes a main refrigerant passage 41, which is a refrigerant supply passage extending in the axial direction X, on the axial center thereof. The main refrigerant passage 41 has a starting end (upstream end 411) which is set at an inlet open on the other end 4B (the end at the side to which no test piece is connected) of the shaft 4 and an ending end (downstream end 412) which is set at a position before the one end 4A (the end to which the test piece is connected) of the shaft 4. In the following description, a direction from the upstream end 411 toward the downstream end 412 in the main refrigerant passage 41 is referred to as a “refrigerant supply direction Y”. The “refrigerant supply direction Y” corresponds to a direction from the other end 4B (the end at the side to which no test piece is connected) toward the one end 4A (the end at the side to which the test piece is connected) in the shaft 4. In the present embodiment, the downstream end 412 of the main refrigerant passage 41 is set on the downstream side in the refrigerant supply direction Y relative to the test piece side bearing 6A. The connecting part 9D of the counter test piece side sub-cover 9B is attached in an inserted state to the upstream end 411 of the main refrigerant passage 41. A through hole 9E which communicates with the main refrigerant passage 41 is formed on the axial center part of the connecting part 9D which projects toward the shaft 4.

The shaft 4 of the present embodiment includes a test piece side sub-refrigerant passage 42 and a counter test piece side sub-refrigerant passage 43. A starting end 421 of the test piece side sub-refrigerant passage 42 and a starting end 431 of the counter test piece side sub-refrigerant passage 43 communicate with the main refrigerant passage 41. In the present embodiment, the starting end 421 of the test piece side sub-refrigerant passage 42 is set at the same position or substantially the same position as the test piece side bearing 6A in the refrigerant supply direction Y. Further, an ending end 422 of the test piece side sub-refrigerant passage 42 is set at a position on the upstream side in the refrigerant supply direction Y relative to the test piece side bearing 6A in the internal space of the casing 2. The test piece side sub-refrigerant passage 42 is a flow passage constituted of a linear through hole which is inclined by a predetermined angle from the starting end 421 toward the ending end 422. Thus, part or the whole of the refrigerant that has flowed through the main refrigerant passage 41 and reached the vicinity of the ending end 412 of the main refrigerant passage 41 flows into the test piece side sub-refrigerant passage 42 through the starting end 421 (inlet) of the test piece side sub-refrigerant passage 42. Then, the refrigerant is emitted into the internal space of the casing 2 through the ending end 422 (outlet) of the test piece side sub-refrigerant passage 42. In the present embodiment, the ending end 422 of the test piece side sub-refrigerant passage 42 is set at the same position or substantially the same position as the end ring 51 (the end ring 51 relatively closer to the test piece side bearing 6A) of the rotor 5 in the refrigerant supply direction Y so that the refrigerant emitted through the ending end 422 (outlet) of the test piece side sub-refrigerant passage 42 is splashed on the end ring 51. The shaft 4 of the present embodiment includes a plurality of test piece side sub-refrigerant passages 42 (e.g., six test piece side sub-refrigerant passages 42) which are formed at constant pitches in the circumferential direction of the shaft 4.

The starting end 431 of the counter test piece side sub-refrigerant passage 43 is set on the upstream side in the refrigerant supply direction Y relative to the end ring 51 closer to the test piece side bearing 6A. Further, an ending end 432 of the counter test piece side sub-refrigerant passage 43 is set on the downstream side in the refrigerant supply direction Y relative to the counter test piece side bearing 6B and at the same position or substantially the same position as the end ring 51 relatively closer to the counter test piece side bearing 6B in the refrigerant supply direction Y in the internal space of the casing 2. In the present embodiment, the shape, the inclination angle, and the number of the counter test piece side sub-refrigerant passage 43 are the same as those of the test piece side sub-refrigerant passage 42. The counter test piece side sub-refrigerant passage 43 of the present embodiment is a flow passage constituted of a linear through hole which is inclined by a predetermined angle from the starting end 431 toward the ending end 432. Thus, part of the refrigerant flowing through the main refrigerant passage 41 flows into the counter test piece side sub-refrigerant passage 43 through the starting end 431 (inlet) of the counter test piece side sub-refrigerant passage 43. Then, the refrigerant is emitted into the internal space of the casing 2 through the ending end 432 (outlet) of the counter test piece side sub-refrigerant passage 43. The rotary machine 1 of the present embodiment is configured in such a manner that the refrigerant emitted through the ending end 432 (outlet) of the counter test piece side sub-refrigerant passage 43 is splashed on the end ring 51 (the end ring 51 closer to the counter test piece side bearing 6B).

The test piece side sub-refrigerant passage 42 and the counter test piece side sub-refrigerant passage 43 both communicate with the main refrigerant passage 41 of the shaft 4 and function as injection nozzles which inject the refrigerant toward the internal space of the casing 2 through the respective discharge ports (the ending end 422 and the ending end 432).

Next, the flow of the refrigerant in the rotary machine 1 of the present embodiment will be described.

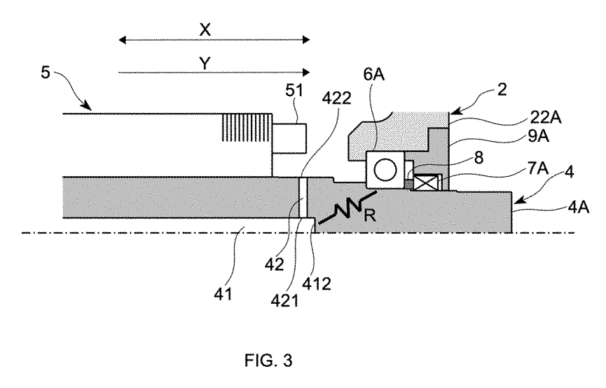

The refrigerant injected into the main refrigerant passage 41 from the other end 4B (the end 4B at the counter test piece side in the shaft 4) through the through hole 9E formed on the connecting part 9D of the counter test piece side sub-cover 9B flows toward the ending end 412 of the main refrigerant passage 41. Accordingly, the rotary machine 1 of the present embodiment is capable of taking heat generated by a frictional loss of the counter test piece side bearing 6B, an electrical loss (a secondary copper loss, an iron loss, or the like) of the rotor 5, and a frictional loss of the test piece side bearing 6A by the refrigerant. In particular, in the rotary machine 1 of the present embodiment, as illustrated in FIG. 2, the downstream end 412 of the main refrigerant passage 41 is set on the downstream side in the refrigerant supply direction Y (the side corresponding to the one end 4A to which the test piece is connected in the shaft 4) relative to the test piece side bearing 6A. Thus, the distance between the test piece side bearing 6A as a heating element and a cooling surface (the main refrigerant passage 41) is shorter than that in a configuration illustrated in FIG. 3, that is, the configuration in which the downstream end 412 of the main refrigerant passage 41 is set on the upstream side in the refrigerant supply direction Y relative to the test piece side bearing 6A. Accordingly, it is possible to reduce a thermal resistance (the thermal resistance schematically indicated by R in FIGS. 2 and 3) to increase a cooling capacity with respect to the test piece side bearing 6A by the refrigerant flowing up to the downstream end 412 of the main refrigerant passage 41. That is, in the configuration illustrated in FIG. 3, since the distance between the test piece side bearing 6A as the heating element and the cooling surface (the main refrigerant passage 41) is long, the thermal resistance is high, and the cooling capacity is thus low. On the other hand, in the rotary machine 1 according to the present embodiment, as illustrated in FIG. 2, the ending end 412 of the main refrigerant passage 41 is set at the position closer to the one end 4A of the shaft 4 than the test piece side bearing 6A is in the axial direction X of the shaft 4 to create the flow of the refrigerant reaching the ending end 412. Accordingly, the distance between the test piece side bearing 6A as the heating element and the cooling surface (the main refrigerant passage 41) is reduced to reduce the thermal resistance, which increases the cooling capacity.

Further, in the rotary machine 1 according to the present embodiment, the refrigerant is injected into the internal space of the casing 2 through the discharge ports (the ending end 422 and the ending end 432) of the test piece side sub-refrigerant passage 42 and the counter test piece side sub-refrigerant passage 43 by the centrifugal force of the rotation of the shaft 4 so that the refrigerant comes into contact with the heating element disposed in the internal space of the casing 2. Accordingly, it is possible to cool the heating element. In particular, since the refrigerant directly comes into contact with the heating element (the end ring 51 in the present embodiment) which is disposed at the same position or substantially the same position as the ending end 422 of the test piece side sub-refrigerant passage 42 or the ending end 432 of the counter test piece side sub-refrigerant passage 43 in the axial direction X of the shaft 4, a higher cooling function is exhibited.

In this manner, the rotary machine 1 according to the present embodiment is capable of not only solving a cooling problem of the test piece side bearing 6A caused by increases in capacity and speed of the rotary machine 1, but also executing a cooling process on a part such as the rotor 5 which has heat inside the casing 2 using the refrigerant discharged into the internal space of the casing 2.

In addition, in the rotary machine 1 according to the present embodiment, the ending end 422 of the test piece side sub-refrigerant passage 42 is set in the internal space (the space at the counter test piece side relative to the test piece side bearing 6A) of the casing 2. Accordingly, it is possible to prevent or reduce leakage of the refrigerant (e.g., or splashed or atomized oil) discharged from the test piece side sub-refrigerant passage 42 to the outside of the rotary machine 1 through a gap near the one end 4A of the shaft 4 (the gap between the shaft 4 and the casing 2, the shaft-end gap).

Further, the rotary machine 1 according to the present embodiment is configured in such a manner that the shape, the number, and the inclination angle of the test piece side sub-refrigerant passage 42 are the same as those of the counter test piece side sub-refrigerant passage 43 so that there is no difference in the centrifugal pump action by the rotation of the shaft 4 between the test piece side and the counter test piece side. When there is a difference in the centrifugal pump action by the rotation of the shaft 4 between the test piece side and the counter test piece side, although the refrigerant can be emitted from the sub-refrigerant passage having a stronger pump action (e.g., the test piece side sub-refrigerant passage 42), the amount of the refrigerant emitted from the sub-refrigerant passage having a weaker pump action (e.g., the counter test piece side sub-refrigerant passage 43) becomes zero or small, which may result in a difference in the cooling effect with respect to the components inside the casing 2 between the test piece side and the counter test piece side. On the other hand, the rotary machine 1 according to the present embodiment is capable of solving such a problem by the above configuration.

The present invention is not limited to the above embodiment. For example, the position of the ending end of the sub-refrigerant passage (the test piece side sub-refrigerant passage, the counter test piece side sub-refrigerant passage) can be appropriately set according to the type of a refrigerant to be used or a usable rotation speed range so that the refrigerant discharged through the ending end of the sub-refrigerant passage is jetted toward the hearing element such as the rotor or the stator present in the internal space of the casing by the action of the centrifugal force.

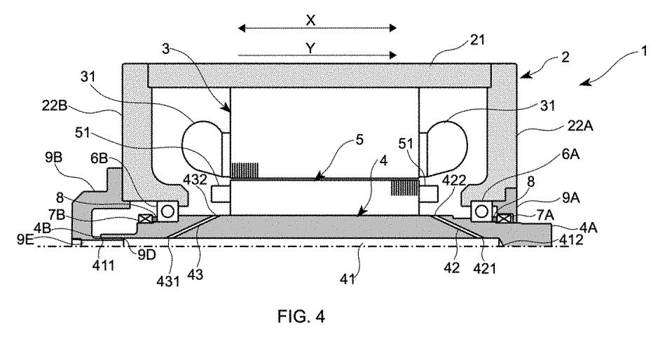

There has been described, as an example, the configuration in which the inclination angle with respect to the main refrigerant passage of the test piece side sub-refrigerant passage is the same as the inclination angle of the counter test piece side sub-refrigerant passage. However, as illustrated in FIG. 4, the orientation of the counter test piece side sub-refrigerant passage 43 may be opposite to the orientation of the test piece side sub-refrigerant passage 42 (the test piece side sub-refrigerant passage 42 and the counter test piece side sub-refrigerant passage 43 may be arranged in an inverted funnel shape in the axial direction X). In modifications of the rotary machine according to the present invention illustrated in the respective drawings of FIG. 4 and thereafter, the same reference signs designate parts identical or corresponding to the parts of the rotary machine 1 illustrated in FIG. 1.

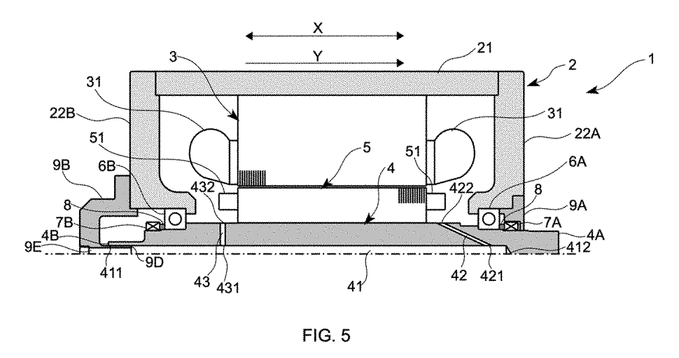

Under the condition where the centrifugal pump action at the test piece side is equal to the centrifugal pump action at the counter test piece side, any one or more of the shape, the inclination angle, and the number may differ between the test piece side sub-refrigerant passage and the counter test piece side sub-refrigerant passage. For example, as illustrated in FIG. 5, the counter test piece side sub-refrigerant passage 43 may be a hole linearly extending in a direction perpendicular to the extending direction of the main refrigerant passage 41 (radial direction).

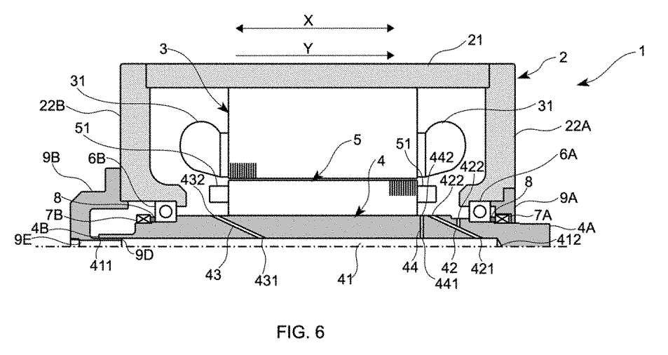

Further, as illustrated in FIG. 6, the test piece side sub-refrigerant passage 42 may be formed in a shape branched midway, the shape having one starting end 421 and a plurality of (two in the illustrated example) ending ends 422 (discharge ports).

Further, as illustrated in FIG. 6, there can be employed a configuration in which a second test piece side sub-refrigerant passage 44 having a starting end 441 which communicates with the main refrigerant passage 41 and an ending end 442 (discharge port) which is open in a space at the test piece side in the internal space of the casing 2 is formed on the upstream side in the refrigerant supply direction Y relative to the test piece side sub-refrigerant passage 42.

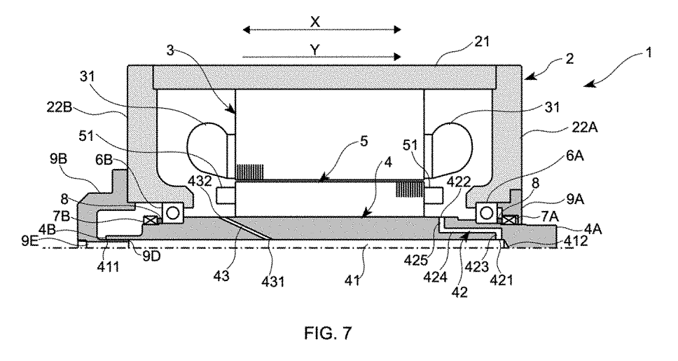

Further, the test piece side sub-refrigerant passage may be formed in a crank shape as illustrated in FIG. 7. That is, a bent test piece side sub-refrigerant passage 42 can be employed. The bent test piece side sub-refrigerant passage 42 includes a part 423 (the first radial part) which extends in the radial direction from the starting end 421 communicating with the main refrigerant passage 41, a part 424 (the thrust part) which extends from an ending end of the radial part 423 toward the counter test piece side (the upstream side in the refrigerant supply direction Y), and a part 425 (the second radial part) which extends in the radial direction from an ending end of the thrust part 424 and communicates with the internal space of the casing 2. Although not illustrated, a test piece side sub-refrigerant passage having a sectional shape other than a linear shape and a crank shape, for example, a bent shape may be employed.

FIGS. 1 and 4 to 7 illustrate the configuration in which the downstream end of the main refrigerant passage is set at the position before the end of the shaft at the side to which the test piece is connected and the same position as the test piece side bearing in the refrigerant supply direction, in other words, the downstream end of the main refrigerant passage is set within the range from the counter test piece side end of the test piece side bearing to the test piece side end of the test piece side bearing. However, there may be employed a configuration in which the downstream end in the refrigerant supply direction of the main refrigerant passage is set at a predetermined position on the downstream side relative to the test piece side bearing, that is, a configuration in which the downstream end in the refrigerant supply direction of the main refrigerant passage is set at a predetermined position on the downstream side in the refrigerant supply direction relative to the test piece side end of the test piece side bearing.

The refrigerant in the present invention is not limited to oil. Water or air can be employed as the refrigerant.

In addition, a specific configuration of each part is not limited to the above embodiment and can be variously modified without departing from the gist of the present invention.

What is claimed is:

1. A rotary machine comprising:
a shaft including a main refrigerant passage capable of supplying a refrigerant in one direction on an axial center part and having one end part to which a test piece can be connected;
a rotor disposed around an axis of the shaft;
a casing capable of housing at least a part of the rotor and a part of the shaft in an internal space of the casing;
a stator fixed inside the casing;
a test piece side bearing that is disposed near the one end part of the shaft and rotatably supports the shaft; and
a counter test piece side bearing that is disposed near the other end part of the shaft and rotatably supports the shaft,
wherein
a downstream end in a refrigerant supply direction of the main refrigerant passage is set at a position before an end of the shaft at a side to which the test piece is connected and the same position as the test piece side bearing or a predetermined position on a downstream side relative to the test piece side bearing in the refrigerant supply direction, and
the shaft includes a test piece side sub-refrigerant passage having a starting end communicating with the downstream end in the refrigerant supply direction or a vicinity of the downstream end in the refrigerant supply direction and an ending end communicating with the internal space of the casing, and the ending end of the test piece side sub-refrigerant passage is set on an upstream side in the refrigerant supply direction relative to the test piece side bearing.

2. The rotary machine according to claim 1, wherein the test piece side sub-refrigerant passage is a flow passage inclined by a predetermined angle from the starting end toward the ending end.

3. The rotary machine according to claim 1, wherein
the shaft includes a counter test piece side sub-refrigerant passage having a starting end communicating with a predetermined part of the main refrigerant passage on the upstream end side in the refrigerant supply direction relative to the test piece side bearing and an ending end communicating with the internal space of the casing on the downstream side in the refrigerant supply direction relative to the counter test piece side bearing, and
the shape, the angle, and the number of the counter test piece side sub-refrigerant passage are the same as the shape, the angle, and the number of the test piece side sub-refrigerant passage.

4. The rotary machine according to claim 2, wherein
the shaft includes a counter test piece side sub-refrigerant passage having a starting end communicating with a predetermined part of the main refrigerant passage on the upstream end side in the refrigerant supply direction relative to the test piece side bearing and an ending end communicating with the internal space of the casing on the downstream side in the refrigerant supply direction relative to the counter test piece side bearing, and
the shape, the angle, and the number of the counter test piece side sub-refrigerant passage are the same as the shape, the angle, and the number of the test piece side sub-refrigerant passage.
